(19) United States
(12) Patent Application Publication
(10) Pub. No.: US 2015/0263496 A1
(43) Pub. Date: Sep. 17, 2015

(54) SHIELD CONDUCTIVE PATH

(71) Applicant: SUMITOMO WIRING SYSTEMS, LTD., Yokkaichi (JP)

(72) Inventors: Hidetoshi SUGINO, Yokkaichi (JP); Masanori KUWAHARA, Yokkaichi (JP); Hidehiko IWAKAWA, Yokkaichi (JP)

(21) Appl. No.: 14/627,535

(22) Filed: Feb. 20, 2015

(30) Foreign Application Priority Data
Mar. 13, 2014 (JP) 2014-050051

(51) Int. Cl. H02G 3/04

(52) U.S. Cl. CPC H02G 3/0437; H02G 3/0487

(57) ABSTRACT

Embodiments of the present application are directed to a shield conductive path that can reduce the height of a shield pipe, and eliminate the need of installation of new equipment. A shield conductive path includes a metal shield pipe that surrounds and shields an electrical wire, and has the cross-sectional shape such that a portion on the upper or lower side of the shield pipe when it is arranged in a vehicle is cut away, and the remaining portion has a shape that corresponds to the shape of a substantially perfect circle. With this, it is possible to reduce the height of the shield pipe, and to eliminate the need of installation of new equipment.

### CROSS-REFERENCE TO RELATED APPLICATIONS

This application claims priority to Japanese Patent Application No. 2014-050051, filed on Mar. 13, 2014, the disclosure of which is incorporated herein by reference in its entirety.

### TECHNICAL FIELD

Embodiments of the present application relate to a shield conductive path.

### BACKGROUND

Conventionally, in vehicles such as hybrid automobiles, electrical wires may be arranged under the floor of the vehicle so as to connect, for example, a device such as a high-voltage battery mounted in the vehicle rear portion and a device such as an inverter or a fuse box mounted in the vehicle front portion. At that time, it is known that the plurality of electrical wires are inserted through a metal shield pipe so as not only to realize a shield function but also to protect the electrical wires from contact with foreign substances.

In a shield conductive path having such a configuration, the shield pipe typically has the cross-sectional shape of a perfect circle (as disclosed in, for example, JP 2007-287335A). Furthermore, the shield pipe is bent into a predetermined shape according to the arrangement route of the electrical wires (as disclosed in, for example, JP 2004-171952A).

JP 2007-287335A and JP 2004-171952A are examples of related art.

### SUMMARY

When a shield conductive path having the above-described configuration is arranged under the floor of a vehicle, it may be necessary to reduce the height of the shield conductive path, taking into consideration the minimum ride height. However, when the cross-sectional shape of a shield pipe is changed, a conventional pipe bender machine cannot be used for bending the shield pipe, and it is thus necessary to install new equipment, such as an enhanced pipe bender machine.

Embodiments of the present application have been made in view of the above-described circumstances, and it is an object of the present application to provide a shield conductive path that can reduce the height of a shield pipe and eliminate the need of installation of new equipment.

The shield conductive path according to embodiments of the present application is directed to a shield conductive path including a shield pipe that surrounds and shields an electrical wire, wherein the shield pipe has a cross-sectional shape such that a portion on the upper or lower side of the shield pipe when the shield pipe is arranged in a vehicle is cut away, and the remaining portion has a shape that corresponds to the shape of a substantially perfect circle.

According to embodiments of the present application, the height of the shield pipe is reduced with respect to that of the conventional shield pipe by the cut-away portion on the upper or lower side, and since the remaining portion corresponds to the shape of a substantially perfect circle such as that of the conventional shield pipe, the conventional pipe bender machine can be used to bend the shield pipe. Accordingly, it is possible to reduce the height of the shield pipe and to eliminate the need of installation of new equipment.

A shield conductive path according to embodiments of the present application may be configured such that the cut-away portion is formed extending from one end of the shield pipe to the other in the axial direction.

According to such a configuration, it is possible to form the cut-away portion of the shield pipe by extrusion molding.

The shield conductive path according to embodiments of the present application may be configured such that the interior of the shield pipe is partitioned by a partition wall into a plurality of electrical wire insertion paths that are aligned in the horizontal direction. With such a configuration, it is possible to efficiently use an internal space of the shield pipe that is narrower, due to the cut-away portion on the upper or lower side thereof, than that of the conventional shield pipe.

Furthermore, the shield conductive path according to embodiments of the present application may be configured such that cut-away portions are formed on both the upper and lower sides of the shield pipe, and the partition wall connects a portion on the upper side of a first wall of the shield pipe, and a portion on the lower side of a second wall of the shield pipe.

According to such embodiments of the present application, the partitioned wall may be integrally formed with both (i) the portion on the upper side of the first wall and (ii) the portion on the lower side of the second wall of the shield pipe.

According still to such embodiments of the present application, the first wall and the second wall of the shield pipe are substantially parallel to each other.

According to embodiments of the present application, the plurality of electrical wire insertion paths that are aligned in the horizontal direction are different sizes.

According to embodiments of the present application, the remaining portion comprises at least two opposing arc walls that are separated from each other by one or both of the upper or lower side of the shield pipe.

### BRIEF DESCRIPTION OF THE DRAWINGS

FIG. 1 illustrates a schematic side view showing an arrangement route of a shield conductive path in accordance with Embodiment 1 of the present application;

FIG. 2 illustrates a schematic plan view showing the state in which the shield conductive path is connected to devices, in accordance with embodiments of the present application;

FIG. 3 illustrates a cross-sectional view taken along the line A-A of FIG. 2, showing the state in which the shield conductive path is arranged under the floor of the vehicle and a configuration of the shield conductive path, in accordance with embodiments of the present application;

FIG. 4 illustrates a cross-sectional view showing the state in which a shield pipe is set in a conventional pipe bender machine, in accordance with embodiments of the present application; and

FIG. 5 illustrates a cross-sectional view showing a configuration of a shield conductive path in accordance with Embodiment 2 of the present application.

### DETAILED DESCRIPTION

As mentioned above, embodiments of the present application provide a shield conductive path that can reduce the height of a shield pipe and eliminate the need of installation of new equipment. The shield conductive path according to embodiments of the present application is directed to a shield conductive path including a shield pipe that surrounds and shields an electrical wire, wherein the shield pipe has a cross-sectional shape such that a portion on the upper or lower side of the shield pipe when the shield pipe is arranged in a vehicle is cut away, and the remaining portion has a shape that corresponds to the shape of a substantially perfect circle. In one embodiment, the shield conductive path is a conductive shield system made and/or defined by one or more components discussed herein.

### Embodiment 1

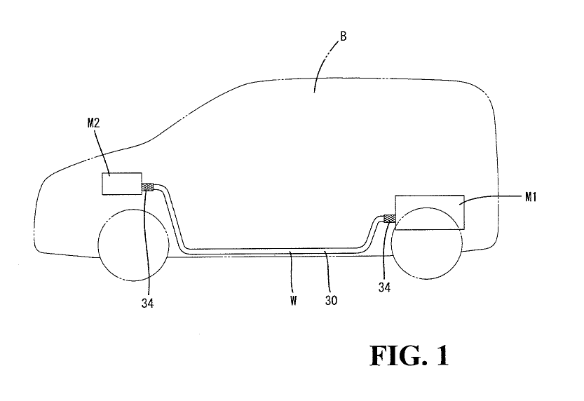

The following will describe Embodiment 1 of the present application which is embodied in detail with reference to FIGS. 1 to 4.

As shown in FIG. 1, a shield conductive path W of the present embodiment is arranged under the floor of a vehicle B such as a hybrid car so as to connect, for example, a device M1 such as a high-voltage battery mounted in the rear portion of the vehicle B and a device M2 such as an inverter or a fuse box mounted in the front portion of the vehicle B. Note that each of the devices M1 and M2 is accommodated in a conductive shield case.

The shield conductive path W of the present embodiment has the configuration in which a plurality (two in the present embodiment) of electrical wires 10 are inserted through a metal shield pipe 30.

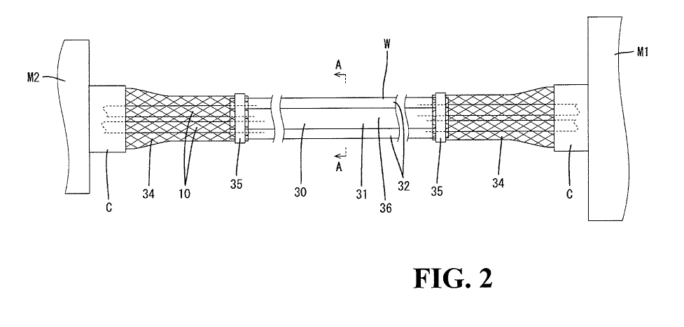

Each electrical wire 10 is a non-shield electrical wire obtained by surrounding the outer circumference of a conductor 11 with an insulating coating 12. Terminal metal fittings (not shown) are connected to the ends of the electrical wires 10 and accommodated in connectors C, which are connected to the respective devices M1 and M2 (see FIG. 2).

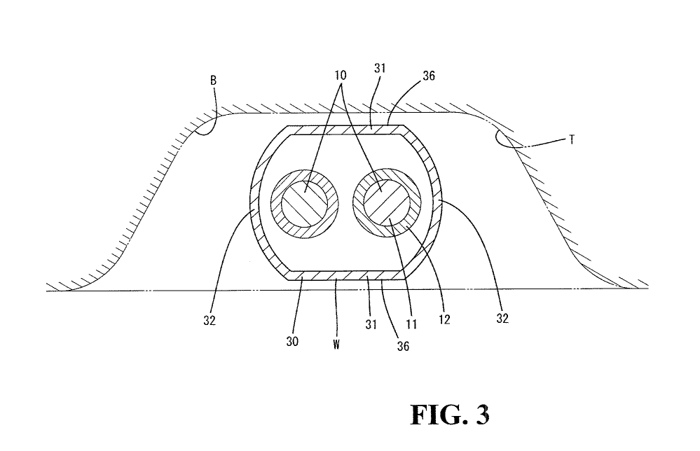

The shield pipe 30 is made of metal (such as iron, aluminium, copper, or stainless steel), and is tubular so as to surround the two electrical wires 10 together (see FIG. 3). The shield pipe 30 is formed, as shown in FIG. 1, into a shape in which it is bent in a three-dimensional direction along the arrangement route of the electrical wires 10. Note that the shield pipe 30 may also be a conductive resin pipe, instead of the metal pipe.

As shown in FIG. 2, portions of the electrical wires 10 that project outward from an end of the shield pipe 30 are surrounded together by a braided member 34. The braided member 34 is formed by knitting conductive thin wires made of metal (e.g., copper) into a mesh structure having a tubular shape. Note that, instead of the braided member 34, a metal foil with or without a slit may also be used to surround those portions of the electrical wires 10.

One end of the braided member 34 is crimped by a metal band 35 and conductively fixed to the outer circumferential face of the shield pipe 30, whereas the other end of the braided member 34 is conductively fixed to the connector C.

The shield pipe 30 has the cross-sectional shape obtained by cutting away portions on both the upper and lower sides of the conventional shield pipe that has the cross-sectional shape of a perfect circle when it is arranged in the vehicle B (see FIG. 3). The portions that were cut away (hereinafter, referred to as the cut-away portions 36) of the shield pipe 30 are formed extending along the entire length from one end of the shield pipe 30 to the other in the axial direction. The cut-away amounts (the height of the portions cut away from the conventional shield pipe) on the upper and lower sides of the shield pipe 30 are the same.

The portions on the upper and lower sides (hereinafter, referred to as cut-away walls 31) of the circumferential wall of the shield pipe 30 are substantially in parallel to each other, and have the same width. Furthermore, according to embodiments of the present application, the portions on both lateral sides (portions that connects the upper and lower cut-away walls 31) of the circumferential wall of the shield pipe 30 are arc walls 32 having an arc-like shape that corresponds to the shape of the conventional shield pipe.

The height of the shield pipe 30 is smaller than the height of the conventional shield pipe by the portions on the upper and lower sides of the shield pipe 30 being cut away. The height of the shield pipe 30 has the size such that the shield pipe 30 is accommodated with a sufficient space in a recess portion T formed under the floor of the vehicle B. In the state in which the shield conductive path W is mounted on and fixed to the vehicle B, the cut-away walls 31 of the shield pipe 30 are arranged horizontally, and are substantially in parallel to the ceiling wall of the recess portion T.

Hereinafter, an example of the operation for manufacturing the shield conductive path W of the present embodiment will be described.

First, two electrical wires 10 are inserted into the shield pipe 30.

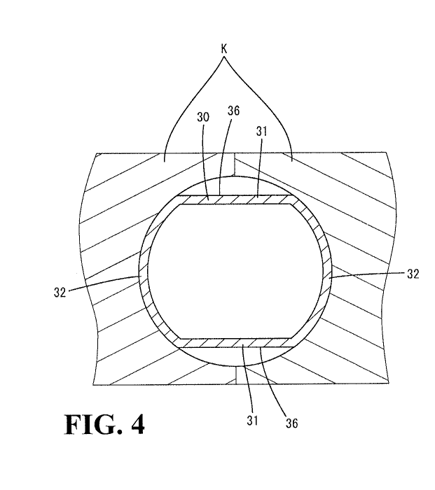

Then, the shield pipe 30 through which the electrical wires 10 are inserted is bent into a predetermined shape. At that time, when the shield pipe 30 is set in a conventionally used pipe bender machine, it is set such that the arc walls 32 on both lateral sides are fitted in a pair of bending dies K without a gap, as shown in FIG. 4. Therefore, the conventional pipe bender machine can still be used to bend the shield pipe 30. According to the bending processing, the shield pipe 30 is plastically deformed into a predetermined shape.

With this, the operation for manufacturing the shield conductive path W is completed.

Hereinafter, the behaviors and effects of the thus configured embodiment will be described.

The shield conductive path W of the present embodiment includes the metal shield pipe 30 that surrounds and shields the electrical wires 10, the shield pipe 30 having the cross-sectional shape such that portions on both the upper and lower sides of the shield pipe 30 when the shield pipe 30 is arranged in the vehicle B are cut away, and the remaining portion has a shape that corresponds to the shape of a substantially perfect circle.

According to this configuration, the height of the shield pipe 30 is reduced with respect to the conventional shield pipe by the cut-away portions on both the upper and lower sides, and since the remaining portion corresponds to the shape of a substantially perfect circle such as that of the conventional shield pipe, the conventional pipe bender machine can be used to bend the shield pipe 30. Accordingly, it is possible to reduce the height of the shield pipe 30 and to eliminate the need of installation of new equipment.

Furthermore, according to embodiments of the present application, the cut-away portions 36 of the shield pipe 30 are formed extending from one end of the shield pipe 30 to the other in the axial direction. According to this configuration, it is possible to form the cut-away portions 36 of the shield pipe 30 by extrusion molding.

### Embodiment 2

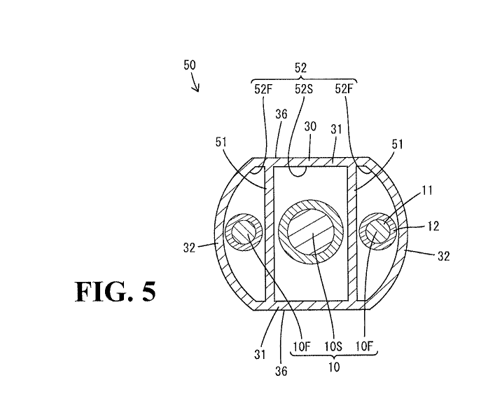

The following will describe a shield conductive path 50 according to Embodiment 2 of the present application which is embodied with reference to FIG. 5.

The shield conductive path 50 of the present embodiment differs from that of Embodiment 1 in that the interior of the shield pipe 30 is partitioned by partition walls 51 into a plurality of electrical wire insertion paths 52 that are aligned in the horizontal direction. Note that the same reference numerals are given to the same configurations of the Embodiment 1, and redundant descriptions are omitted.

Similarly to Embodiment 1, the shield conductive path 50 according to the present embodiment includes the metal shield pipe 30 that surrounds and shields electrical wires 10, the shield pipe 30 having the cross-sectional shape such that portions on both the upper and lower sides of the shield pipe 30 when the shield pipe 30 is arranged in the vehicle B are cut away, and the remaining portion has a shape that corresponds to the shape of a substantially perfect circle. Furthermore, similarly to Embodiment 1, according to embodiments of the present application, the portions on the upper and lower sides of the circumferential wall of the shield pipe 30 serve as the cut-away walls 31 that are substantially in parallel to each other, and the portions on both lateral sides of the circumferential wall of the shield pipe 30 serve as the arc walls 32 that correspond to the shape of the conventional shield pipe.

In the present embodiment, the electrical wires 10 include two different types of electrical wires (hereinafter, referred to as “first electrical wire 10F” and “second electrical wire 10S”). Specifically, in the present embodiment, the first electrical wire 10F is a high-voltage electrical wire that connects the device M1 such as a high-voltage battery mounted in the vehicle rear portion and the device M2 such as an inverter mounted in the vehicle front portion, and the second electrical wire is a low-voltage electrical wire that connects the device M1 such as a low-voltage battery mounted in the vehicle rear portion and the device M2 such as a fuse box mounted in the vehicle front portion. Two first electrical wires 10F and one second electrical wire 10S are provided.

Note that the electrical wires may also be ones that are connected not only to the devices exemplified here but also to various types of devices. For example, if a low-voltage battery is mounted in the vehicle front portion, the electrical wires may connect a DC/DC converter mounted in the vehicle rear portion and the low-voltage battery mounted in the vehicle front portion.

Each of the first electrical wires 10F and the second electrical wire 10S is a non-shield electrical wire obtained by surrounding the outer circumference of the conductor 11 with the insulating coating 12. The first electrical wires 10F are high-voltage electrical wires that form a high-voltage circuit, through which a high-voltage and large current can flow. Furthermore, according to embodiments of the present application, the second electrical wire 10S is a low-voltage electrical wire that forms a low-voltage circuit, which does not require any protection against noise. Note that the diameter of the first electrical wire 10F is smaller than the diameter of the second electrical wire 10S.

The pair of partition walls 51 for partitioning the internal space of the shield pipe 30 into a plurality (three in the present embodiment) of electrical wire insertion paths 52 is provided in the shield pipe 30. Each partition wall 51 of the pair connects the upper cut-away wall 31 and the lower cut-away wall 31. The partition walls 51 are located near the respective ends in the width direction of the cut-away walls 31. Both of the partition walls 51 are substantially vertical to the cut-away walls 31. Note that both of the partition walls 51 have the same thickness as that of the circumferential wall of the shield pipe 30.

Two of the three electrical wire insertion paths 52 that are located on the respective ends are electrical wire insertion paths (hereinafter, referred to as first insertion paths 52F) through which the first electrical wires 10F are inserted, and the other one electrical wire insertion path located therebetween is an electrical wire insertion path (hereinafter, referred to as a second insertion path 52S) through which the second electrical wire 10S is inserted.

The second insertion path 52S is formed so as to have a rectangular cross-sectional shape with the pair of right and left partition walls 51 and the pair of upper and lower cut-away walls 31. The first insertion paths 52F are shaped such that the centers thereof in the up-down direction extend outward to the furthest extent according to the arc walls 32. Note that the first insertion paths 52F have the same size in area.

One first electrical wire 10F is inserted through each first insertion path 52F, and one second electrical wire 10S is inserted through the second insertion path 52S. Accordingly, three electrical wires 10F and 10S are arranged and aligned in the horizontal direction. Furthermore, according to embodiments of the present application, the pair of first electrical wires 10F are arranged at positions farthest away from each other in the shield pipe 30.

In this way, the electrical wires 10F and 10S are arranged so as to be separated from each other by the partition walls 51, and thus the second electrical wire 10S is prevented from being affected by noise from the first electrical wires 10F in the shield pipe 30.

As described above, according to the present embodiment, since the interior of the shield pipe 30 is partitioned by the partition walls 51 into the plurality of electrical wire insertion paths 52 that are aligned in the horizontal direction, it is possible to efficiently use the internal space of the shield pipe 30 that is smaller, due to the cut-away portions on the upper or lower side thereof, than that of the conventional shield pipe.

### OTHER EMBODIMENTS

Embodiments of the present application are not limited to the embodiments that have been described using the foregoing description and the drawings, and, for example, embodiments as described below are also encompassed within the technical scope of the present application.

(1) In the embodiments above, the shield pipe 30 has a cross-sectional shape such that both portions on the upper and lower sides of the shield pipe 30 when the shield pipe 30 is arranged in the vehicle B are cut away. However, embodiments of the present application are not limited to this, and the shield pipe may also have a cross-sectional shape such that only the upper portion or the lower portion when the shield pipe 30 is arranged in the vehicle body is cut away.

(2) In the embodiments above, the upper and lower cut-away walls 31 are horizontal. However, embodiments of the present application are not limited to this, and the cut-away walls may also have, for example, an arc-like shape that is curved shallower than a perfect circle or the shape of a shallow inclination.

(3) In the embodiments above, the upper and lower cut-away amounts of the shield pipe 30 are the same. However, embodiments of the present application are not limited to this, and the upper and lower cut-away amounts may also be different.

(4) In the embodiments above, the number of electrical wires are defined as two or three. However, embodiments of the present application are not limited to this, and the number of the electrical wires may also be one or four or more, that is, any number of the electrical wires may be used depending on the connection aspect.

(5) In the embodiments above, the electrical wires 10 are inserted through the shield pipe 30 and then the shield pipe 30 is bent. However, embodiments of the present application are not limited to this, and a configuration is also possible in which the shield pipe is bent and then the electrical wires are inserted therethrough.

(6) In the foregoing Embodiment 2 of the present application, the present application has been described with reference to a case in which a plurality of electrical wires 10 include high-voltage electrical wires and a low-voltage electrical wire. However, embodiments of the present application are appropriately applicable to a case where when a plurality of electrical wires are arranged close to each other, an influence of electromagnetic noise on the electrical wires is concerned, namely, the case where the electrical wires includes a power supply line, a signal line and the like, for example.

(7) In the foregoing Embodiment 2 of the present application, the interior of the shield pipe 30 is partitioned into three electrical wire insertion paths 52. However, embodiments of the present application are not limited to this, and the number of the electrical wire insertion paths that are provided in the shield pipe may be suitably changed according to the type of the electrical wires that are desired to be arranged separately from each other.

(8) In the foregoing Embodiment 2 of the present application, the interior of the shield pipe 30 is partitioned into three electrical wire insertion paths 52 for the two types of electrical wires 10F and 10S. However, embodiments of the present application are not limited to this, and the interior of the shield pipe may also be partitioned into two electrical wire insertion paths for two types of electrical wires. Further, it will be understood that although specific embodiments have been illustrated and described herein, those of ordinary skill in the art appreciate that any arrangement which is calculated to achieve the same purpose may be substituted for the specific embodiments shown and that embodiments of the invention have other applications in other environments. The present application is intended to cover any adaptations or variations of the present invention. The following claims are in no way intended to limit the scope of embodiments of the invention to the specific embodiments described herein.

### LIST OF REFERENCE NUMERALS

B . . . Vehicle
W, 50 . . . Shield conductive path
10 . . . Electrical wire
30 . . . Shield pipe
31 . . . Cut-away wall (portions on the upper and lower sides of the circumferential wall of the shield pipe)
36 . . . Cutaway portion (portion that was cut away)
51 . . . Partition wall
52 . . . Electrical wire insertion path

1. A shield conductive path comprising a shield pipe that surrounds and shields an electrical wire,
wherein the shield pipe has a cross-sectional shape such that a portion on an upper or a lower side of the shield pipe when the shield pipe is arranged in a vehicle is cut away, and the remaining portion has a shape that corresponds to a shape of a substantially perfect circle.

2. The shield conductive path according to claim 1,
wherein the cut-away portion is formed extending from one end of the shield pipe to another end of the shield pipe in an axial direction.

3. The shield conductive path according to claim 1,
wherein the interior of the shield pipe is partitioned by a partition wall into a plurality of electrical wire insertion paths that are aligned in a horizontal direction.

4. The shield conductive path according to claim 3,
wherein cut-away portions are formed on both the upper and the lower sides of the shield pipe, and the partition wall connects a portion on the upper side of a first wall of the shield pipe, and a portion on the lower side of a second wall of the shield pipe.

5. The shield conductive path according to claim 2, wherein the interior of the shield pipe is partitioned by a partition way into a plurality of electrical wire insertion paths that are aligned in a horizontal direction.

6. The shield conductive path according to claim 5, wherein the cut-away portions are formed on both the upper and the lower sides of the shield pipe, and the partition wall connects a portion on the upper side of a first circumferential wall of the shield pipe, and a portion on the lower side of a second circumferential wall of the shield pipe.

7. The shield conductive path according to claim 4,
wherein the partition wall is integrally formed with both (i) the portion on the upper side of the first wall and (ii) the portion on the lower side of the second wall of the shield pipe.

8. The shield conductive path according to claim 3, wherein the plurality of electrical wire insertion paths that are aligned in the horizontal direction are different sizes.

9. The conductive path according to claim 4, wherein the first wall and the second wall of the shield pipe are substantially parallel to each other.

10. The conductive path according to claim 1, wherein the remaining portion comprises at least two opposing arc walls that are separated from each other by one or both of the upper or lower side of the shield pipe.

11. A system comprising:
a shield pipe that surrounds and shields an electrical wire, wherein the shield pipe has a cross-sectional shape such that a portion on an upper or a lower side of the shield pipe when the shield pipe is arranged in a vehicle is cut away, and the remaining portion has a shape that corresponds to a shape of a circle.

12. The system according to claim 11,
wherein the cut-away portion is formed extending from one end of the shield pipe to another end of the shield pipe in an axial direction.

13. The system according to claim 11,
wherein the interior of the shield pipe is partitioned by a partition wall into a plurality of electrical wire insertion paths that are aligned in a horizontal direction.

14. The system according to claim 11, further comprising a vehicle that comprises the shield pipe.

15. A method for manufacturing a shield conductive path, the method comprising:
providing a shield pipe that surrounds and shields an electrical wire;
inserting at least one electrical wire into the shield pipe; and
deforming the shield pipe, through which the electrical wires are inserted, into a predetermined shape so that the shield pipe has a cross-sectional shape whereby a portion on an upper or a lower side of the shield pipe when the shield pipe is arranged in a vehicle is cut away, and the remaining portion has a shape that corresponds to a shape of a circle.
